(19) United States
(12) Patent Application Publication
(10) Pub. No.: US 2010/0147126 A1
(43) Pub. Date: Jun. 17, 2010

(54) ROTARY DIE CUTTER

(75) Inventors: Yang Zhang, Shenzhen City (CN); Bin Zhao, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/423,815

(22) Filed: Apr. 15, 2009

(30) Foreign Application Priority Data
Dec. 12, 2008 (CN) 200810306197.6

(51) Int. Cl. B23D 25/12

(52) U.S. Cl. 83/344

(57) ABSTRACT

A rotary die cutter includes a plate cylinder and two bearer members provided at two opposite ends of the plate cylinder. The plate cylinder has a receiving cavity therein and a plurality of annular knife blades formed on an outer cylindrical surface thereof. A plurality of intake ports is defined in the plate cylinder. Each intake port is surrounded by a corresponding knife blade and in communication with the cavity in the plate cylinder. The plate cylinder defines a discharging hole in a periphery wall thereof and in communication with the cavity.

### BACKGROUND

1. Technical Field

The disclosure relates to a rotary die cutting device and, more particularly, to a rotary die cutter for punching a material belt.

2. Description of Related Art

It is well known that removing waste material is a key of die cutting processes. How to remove scrap pieces with little size in die cutting processes from punching holes in a material belt is important in the processes.

As shown in FIG. 1, a conventional die cutting device 3 and an anvil cylinder 5 each are mounted for rotation in any normal manner about their respective longitudinal axes and for cooperating with each other for the die cutting of a material belt 1 passing therebetween. A conventional way to remove scrap pieces 4 from the material belt 1 is usually referred to a low tape 2 disposed under the material belt 1. The scrap pieces 4 are adhered to the low tape 2 after being cut off from the material belt 1, thereby to be brought away from the material belt 1 by the low tape 2; thus, the problem of removing the waste material is resolved. However, the conventional way of removing waste material is uneconomical and inconvenient. Since the low tape 2 is one-off, it is enormously consumed in mass production to therefore increase cost of manufacturing. In addition, the one-off low tape 2 should be replaced many times since it is easy to be exhausted. Each time of replacing the low tape 2, the die cutting device 3 should be re-adjusted to fit for some required parameters. Thus, it is very time-consuming to continually replace the low tapes 2 and re-adjust the die cutting device 3.

What is needed, therefore, is an improved rotary die cutter which can overcome the above problems.

### BRIEF DESCRIPTION OF THE DRAWINGS

Other advantages and novel features of the disclosure will become more apparent from the following detailed description of an embodiment/embodiments when taken in conjunction with the accompanying drawings.

FIG. 1 is a schematic view of die cutting processes of the related art.

FIG. 2 is an isometric, assembled view of a rotary die cutter in accordance with an embodiment of the disclosure.

FIG. 3 is an exploded view of the rotary die cutter of FIG. 2.

### DETAILED DESCRIPTION

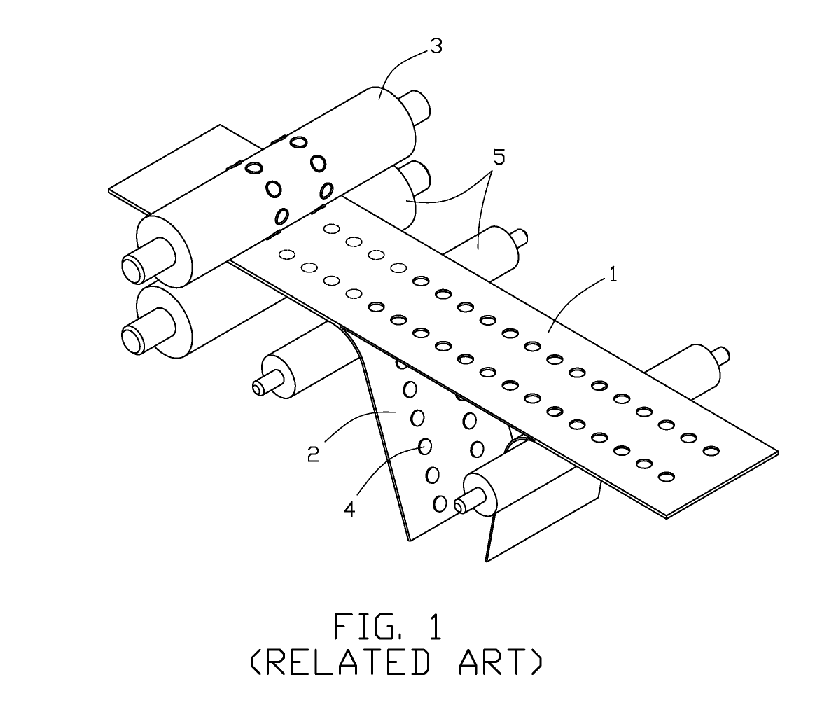

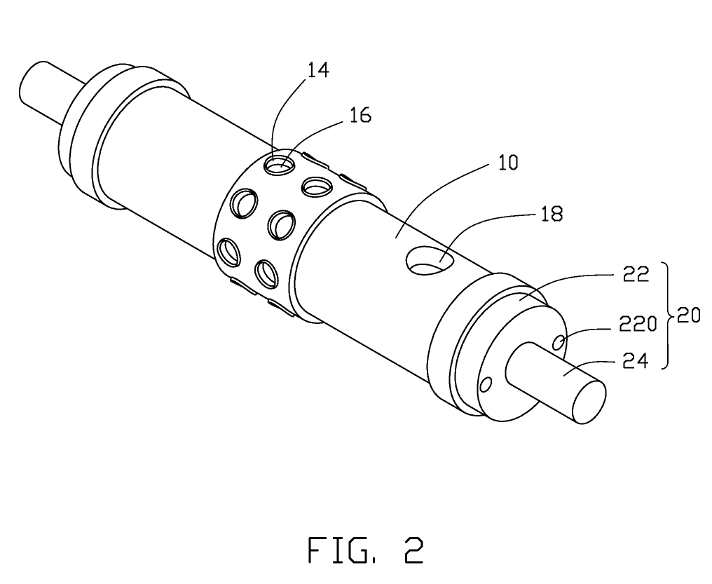

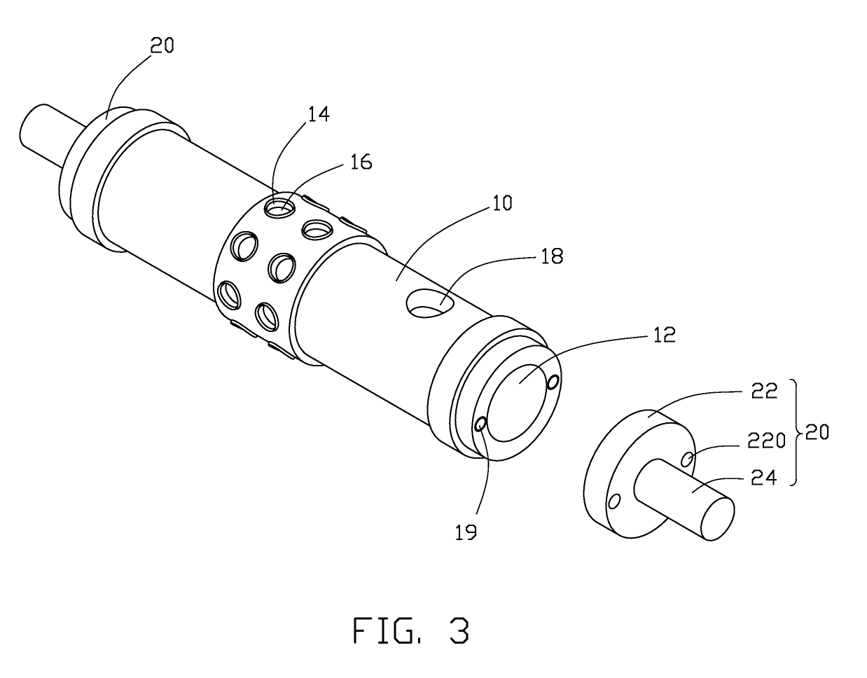

Elements except a rotary die cutter which will be described hereinafter are all the same as those shown in FIG. 1, so only the rotary die cutter is shown in FIGS. 2-3, while the other elements can find in FIG. 1. Nevertheless, the low tape 2 of FIG. 1 is not necessary in the rotary die cutter of the present disclosure. Referring to FIGS. 2-3, the rotary die cutter of the present disclosure is used in die cutting processes for punching holes with small size in a material belt 1. The rotary die cutter comprises a plate cylinder 10 and two similar bearer members 20 provided at two opposite ends of the plate cylinder 10.

The plate cylinder 10 has a plurality of die cutting surfaces thereon either spaced from or in interference with an anvil surface of the anvil plate 5 located thereunder, depending on a diameter of the plate cylinder 10. The cutting surfaces can be various forms in different embodiments of the present invention and are preferred to be a plurality of annular knife blades 14 formed on an outer cylindrical surface of the plate cylinder 10. The annular knife blades 14 are arranged in two rows at a middle portion of the outer cylindrical surface of the plate cylinder 10. The plate cylinder 10 defines a plurality of spaced intake ports 16 in a periphery wall thereof. Each intake port 16 is surrounded by a corresponding annular knife blade 14 and has a caliber similar to that of the annular knife blade 14. The plate cylinder 10 defines a cavity 12 therein for receiving scrap pieces 4 cut off from the material belt 1 and a discharging hole 18 in the periphery wall thereof. The discharging hole 18 is a through hole extending through the diameter of the plate cylinder 10. The discharging hole 18 and the intake ports 16 are all in communication with the cavity 12 in the plate cylinder 10 for allowing the scrap pieces 4 cut off by the annular knife blades 14 from the material belt 1 to move into the cavity 12 of the plate cylinder 10 through the intake ports 16 and be discharged from the cavity 12 via the discharging hole 18.

Each of the bearer members 20 comprises a bearer plate 22 fixed to one end of the plate cylinder 10 and a spindle 24 extending outwardly and perpendicularly from a center of an outer side of the bearer plate 22 for supporting the rotary die cutter on a bearing (not shown). Each plate cylinder 22 defines two spaced receiving holes 220 for receiving two screws (not shown). The screws engage in two threaded holes 19 in each of two opposite ends of the plate cylinder 10 to couple the two bearer members 20 and the plate cylinder 10 together.

In use, the rotary die cutter of the disclosure replaces the conventional die cutting device 3 in FIG. 1 to cut the material belt 1 without setting the low tape 2. The scrape pieces 4 cut off from the material belt 1 by the rotating knife blades 14 of the plate cylinder 10, are then drew into the cavity 12 of the plate cylinder 10 due to the rotation of the plate cylinder 10 and the adherence of the scrape pieces 4 in the intake ports 16. Once the cavity 12 of the plate cylinder 10 is almost fully filled with the scrap pieces 4 from the material belt 1, the scrap pieces 4 could be conveniently discharged through the discharging hole 18 of the plate cylinder 10 thereby to clear the scrape pieces 4 from the cavity 12 of the plate cylinder 10. After a long period of use, the bearer member 20 can be removed from the plate cylinder 10 to completely clear the residuary scrap pieces 4 from the cavity 12, which are remained in the cavity 12 and not removed therefrom via the discharging hole 18.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A rotary die cutter, comprising:
a plate cylinder having a receiving cavity therein and a plurality of die cutting surfaces on an outer cylindrical surface thereof and defining a plurality of intake ports in a periphery wall thereof, each intake port surrounded by a corresponding die cutting surface and in communication with the cavity in the plate cylinder; and
two bearer members provided at two opposite ends of the plate cylinder.

2. The rotary die cutter as claimed in claim 1, wherein the die cutting surfaces comprise a plurality of annular knife blades protruding outwardly and radially from the outer cylindrical surface of the plate cylinder.

3. The rotary die cutter as claimed in claim 2, wherein the annular knife blades are spaced from each other and arranged in two rows at a middle portion of the outer cylindrical surface.

4. The rotary die cutter as claimed in claim 3, wherein each intake port is surrounded by a corresponding annular knife blade, and each intake port has a caliber similar to that of each annular knife blade.

5. The rotary die cutter as claimed in claim 1, wherein the plate cylinder defines a discharging hole in the periphery wall thereof, which is in communication with the cavity in the plate cylinder, the discharging hole being provided for facilitating clear of scrape pieces from the receiving cavity, the scrape pieces being cut by the die cutting surfaces from a material belt and entering the receiving cavity via the intake ports.

6. The rotary die cutter as claimed in claim 1, wherein each the bearer member comprises a bearer plate fixed to one end of the plate cylinder and a spindle extending outwardly and perpendicularly from a center of an outer side of the bearer plate.

7. The rotary die cutter as claimed in claim 6, wherein each plate cylinder defines two spaced receiving holes for receiving two screws which engage with a corresponding end of the plate cylinder to couple the bearer member and the plate cylinder together.

8. A rotary die cutter, comprising:
a plate cylinder having a receiving cavity therein and a plurality of annular knife blades formed on an outer cylindrical surface thereof, a plurality of intake ports being defined in the a periphery wall of the plate cylinder, each intake port surrounded by a corresponding knife blade and in communication with the cavity in the plate cylinder, the plate cylinder defining a discharging hole in the periphery wall thereof and in communication with the cavity, the discharging hole being provided for facilitating clear of scrape pieces from the receiving cavity, the scrape pieces being cut by the annular knife blades from a material belt and entering the receiving cavity via the intake ports; and
two bearer members provided at two opposite ends of the plate cylinder.

9. The rotary die cutter as claimed in claim 8, wherein each intake port has a caliber similar to that of each annular knife blade.

10. The rotary die cutter as claimed in claim 8, wherein each bearer member comprises a bearer plate fixed to one end of the plate cylinder and a spindle extending outwardly and perpendicularly from a center of an outer side of the bearer plate.
